(19) United States
(12) Patent Application Publication
(10) Pub. No.: US 2013/0191675 A1
(43) Pub. Date: Jul. 25, 2013

(54) METHOD AND SYSTEM FOR PROVIDING BACKUP POWER FOR MEMORY DEVICES

(71) Applicants: David W. Glass, Georgetown, KY (US); Michael D. Hocker, Staatsburg, NY (US)

(72) Inventors: David W. Glass, Georgetown, KY (US); Michael D. Hocker, Staatsburg, NY (US)

(73) Assignee: INTERNATIONAL BUSINESS MACHINES CORPORATION, Armonk, NY (US)

(21) Appl. No.: 13/356,755

(22) Filed: Jan. 24, 2012

(51) Int. Cl. G06F 1/28; G06F 12/16

(52) U.S. Cl. 713/340

(57) ABSTRACT

According to exemplary embodiments, a computer program product for providing voltage to a memory device includes a tangible storage medium readable by a processing circuit and storing instructions for execution by the processing circuit for performing a method. The method performed includes storing data on the memory device, providing a voltage from a finite energy storage medium to the memory device when power is not provided by an associated computing system and measuring the voltage provided. The method also includes boosting the voltage provided by the finite energy storage medium via a switching voltage regulator responsive to the voltage being below a threshold, wherein the switching voltage regulator is coupled to the finite energy storage medium.

### BACKGROUND

The present invention relates to memory systems, and more specifically, to methods and systems to provide backup power for memory devices.

Certain computing systems have a need for maintaining important data in a memory device that is preserved when power to the memory device is lost or the memory device is not installed in a system. For example, financial institutions may communicate critical information that is encrypted and decrypted by cryptographic adapter modules installed on computing systems located on site. The cryptographic adapter modules include memory devices, such as static random access memory (SRAM) that store encryption and decryption data and information. This data should be maintained in the SRAM when the cryptographic adapters are not powered by a primary power source, such as before the module is installed in the computing systems. In some cases, the SRAM used by the cryptographic adapters is backed up with a battery to preserve the data used for cryptographic operations when the adapter is not powered by the computing system.

Such “battery backed” memory system configurations may use a combination of a memory device and a long life battery such as a lithium cell battery. Memory devices typically require a selected voltage input, called a retention voltage, to retain data within the device. After a period of time, the voltage supplied by the battery begins to decrease, primarily due to diminished battery capacity and the increasing internal resistance of the battery. Accordingly, the battery voltage supplied to the memory device may drop below the memory device's retention voltage, which may lead to loss of important data.

### SUMMARY

According to exemplary embodiments, a computer program product for providing voltage to a memory device includes a tangible storage medium readable by a processing circuit and storing instructions for execution by the processing circuit for performing a method. The method performed includes storing data on the memory device, providing a voltage from a finite energy storage medium to the memory device when power is not provided by an associated computing system and measuring the voltage provided. The method also includes boosting the voltage provided by the finite energy storage medium via a switching voltage regulator responsive to the voltage being below a threshold, wherein the switching voltage regulator is coupled to the finite energy storage medium.

According to further exemplary embodiments, a method for providing voltage to a memory device includes storing data on the memory device and providing a voltage from a finite energy storage medium to the memory device when power is not provided by an associated computing system. The method also includes measuring the voltage provided and boosting the voltage provided by the finite energy storage medium via a switching voltage regulator responsive to the voltage being below a threshold, wherein the switching voltage regulator is coupled to the finite energy storage medium.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 illustrates a schematic diagram of a user system, host system and network according to an embodiment of the present invention;

FIG. 2 illustrates a block diagram portion of an cryptography module in accordance with an embodiment of the present invention; and

FIG. 3 illustrates a graph of voltage provided by a power source in accordance with an embodiment of the present invention.

### DETAILED DESCRIPTION

Computing and networked systems may utilize circuits or cards that have important data stored on memory devices, such as SRAM, that have a selected threshold voltage input, called a retention voltage, necessary to maintain the data. Embodiments are provided that include a battery and switching voltage regulator to provide backup power when the memory device is not powered by a primary power source, such as an associated computing system. The switching voltage regulator is configured to provide a boost of voltage supplied by the battery when the voltage decreases after a period of time and approaches the retention voltage for the memory device. In an embodiment, the switching voltage regulator “scavenges” the battery to provide the voltage boost from residual battery capacity and other energy in the circuit that would otherwise not be useable to retain data in the memory device. In embodiments, the switching voltage regulator is in a low power standby mode when the battery is supplying voltage greater than the retention voltage and switches to an active mode when the voltage supplied by the battery approaches the retention voltage. The low power standby mode (also called “passive mode”) preserves battery power by having the regulator in the low power state until the regulator is needed. In one embodiment, the system is configured to notify a user when the supplied voltage approaches the retention voltage or when the regulator is in the active mode.

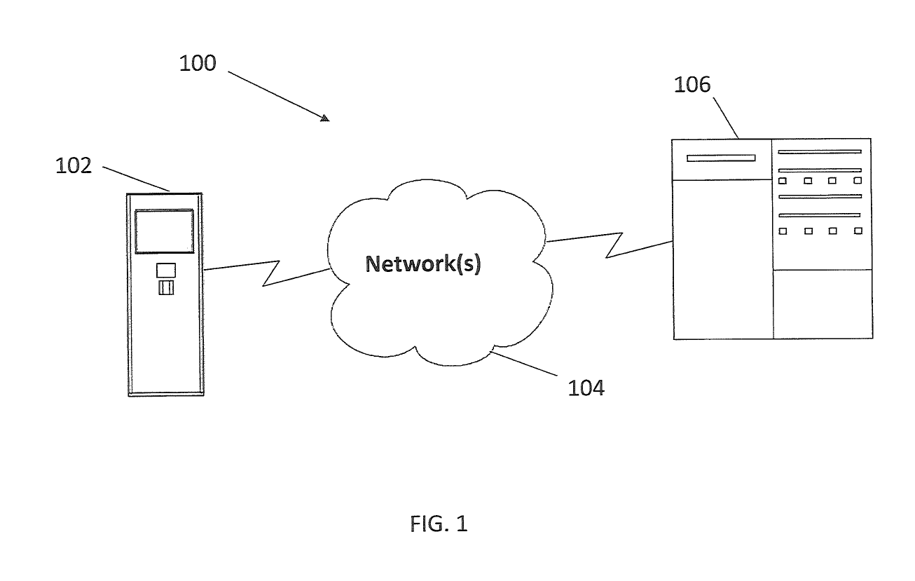

With reference now to FIG. 1, an exemplary system 100 for providing improved power backup for a memory device will now be described. The system 100 includes a user system 102 in communication over one or more networks 104 with a host system 106. The user system 102 and host system 106 may each be computing systems include a module, such as a cryptographic processing card or hardware security module (HSM), with information saved on a memory device where the information is used to facilitate secure communication of sensitive information over the networks 104.

In the depicted embodiment, the user system 102 is a payment terminal, such as an automated teller machine (ATM) or kiosk, configured to receive user information, such as account information or account PIN. The host system 106 may be a financial institution connected to the user system 102 via one or more of the network(s) 104. The important data, such as cryptographic key material or tokens, is stored in the host system 106. The financial institution receives encrypted data from the terminal user system 102 over the network 104, which may include an account number and PIN information that is encrypted and decrypted using the stored data.

The network(s) 104 may be any type of known networks including, but not limited to, a wide area network (WAN), a local area network (LAN), a global network (e.g., Internet), a virtual private network (VPN), and an intranet. The network 104 may be implemented using a wireless network or any kind of physical network implementation known in the art. The user system 102 may be coupled to the host system 106 through multiple networks (e.g., intranet and Internet). One or more user systems 102 and the host system 106 may be connected to the network 104 in a wired or wireless fashion. In one embodiment, the network 104 is an intranet and one or more user systems 102 execute a user interface application (e.g., a web browser) to contact the host system 106 through the network 104. In another exemplary embodiment, one or more of the user systems 102 is connected directly (i.e., not through the network 104) to the host system 106.

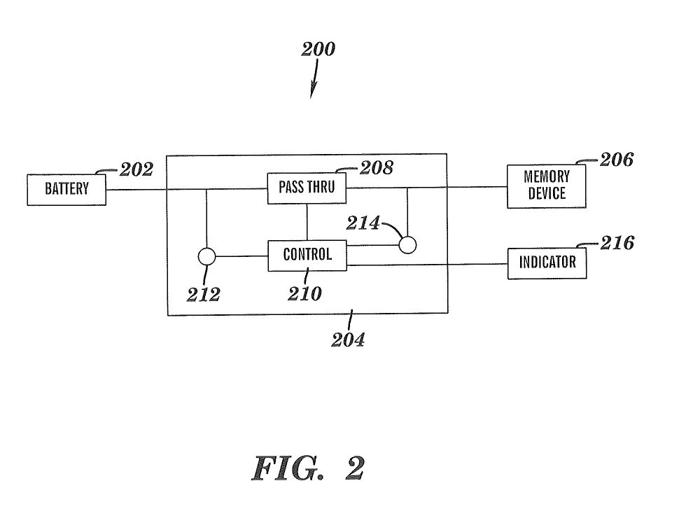

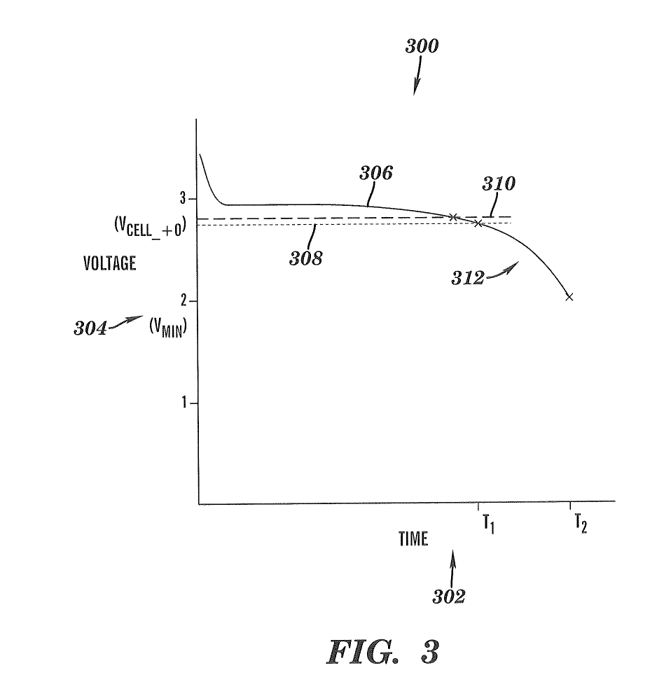

The host system 106 depicted in FIG. 1 may be implemented using one or more servers operating in response to a computer program stored in a storage medium accessible by the server. The host system 106 may include one or more hardware security modules (HSMs), such as a card, software and firmware configured to create and manage tokens containing the key material as described herein. The exemplary methods and structures for providing power to memory devices discussed below with reference to FIGS. 2-3 may be performed by components of the system 100 of FIG. 1.

Referring now to FIG. 2, a diagram of a portion of an exemplary cryptographic module 200 is shown. The cryptographic module 200 includes a battery 202, a switching voltage regulator 204 and a memory device 206. In an embodiment, the memory device 206 receives power via a bus or other suitable hardware from a primary power source, such as an associated computer that receives the cryptographic module 200. One example of the associated computer is the host system 106 (FIG. 1). The battery 202 and switching voltage regulator 204 provide power to the memory device 206 when the primary power source (e.g., associated computing system) is not available. The battery 202 may be any suitable battery with an extended life, such as a lithium ion battery. Alternative types of a power source or battery 202 include but are not limited to NiCd, NiMH, lead acid and carbon zinc. Any suitable finite energy storage medium may be used in place of the battery 202 in the depicted embodiments. The switching voltage regulator 204 includes a pass thru element 208, a control module 210 and sensors 212, 214. The sensor 212 is configured to measure the voltage provided by the battery 202 to the memory device 206. The provided voltage passes through the pass thru element 208 which is in an active or passive mode depending on the voltage sensed by sensor 212. The control module 210 controls or switches the mode of the pass thru element 208 based on programming logic and the sensed voltage from the sensor 212. The sensor 214 measures the voltage provided to the memory device 206, where the provided voltage may vary depending on the state of the pass thru element 208. The output voltage measured by sensor 214 provides a feedback path for the switching voltage regulator 204. In one embodiment, the memory device 206 is a SRAM device that requires supply of a retention voltage that is necessary to retain the information or data stored therein. If the provided voltage falls below the retention voltage, data integrity may be compromised and the data stored in the memory device 206 may be lost. In an embodiment, an indicator 216, such as an audible or visual indicator, notifies a user when the provided voltage falls to within a selected range of the retention voltage. The notification identifies to the user that there is a potential of data loss in the future if a suitable power source is not provided to power the memory device 206. The selected range for notification may be within a selected voltage range, such as within 5% of the retention voltage. In other embodiments, the indicator 216 notifies the user when the switching voltage regulator 204 and pass thru element 208 change from the passive to the active mode.

In an embodiment, the battery 202 provides a selected voltage level for a period of time, wherein the voltage provided drops over time, as shown in FIG. 3 by an exemplary graph 300. The graph 300 has Time plotted on an x-axis 302 and Voltage plotted on a y-axis 304. Plot 306 shows the voltage over time provided by a battery, where the battery 202 provides about 3 Volts (V) for a period of time after the battery 202 is new. A retention voltage 308 is the threshold voltage at which the battery 202 maintains data integrity for the memory device 206 As depicted, the battery 202 provides a voltage at or above the retention voltage 308 until time T1, at which time the provided voltage approaches the retention voltage 308. Accordingly, the switching voltage regulator 204 and pass thru element 208 are in a passive or standby mode until time T1. When the pass thru element 208 is in the passive mode, the voltage sensed at sensor 212 and the voltage sensed at sensor 214 is substantially equal. In an embodiment, the sensor 212 measures the voltage shown in the plot 306. The voltage plot 306 reaches a threshold voltage 310 as it approaches the retention voltage 308, where the sensor 212 measurement of the threshold voltage causes the control module 210 to switch the pass thru element 208 from the passive mode to the active mode. While in the active mode, the pass thru element 208 causes the provided voltage to be boosted to a value at or above the threshold voltage 310 by scavenging residual power from the battery 202. In one embodiment, the threshold value 310 is a guard band or safety factor value (e.g., 2-5% of the retention voltage) greater than the retention voltage 308 value.

In an embodiment, the pass thru element 208 (in the active mode) includes circuitry, such as an inductor, configured to provide an induced voltage which boosts the voltage provided to the memory device 206 by the battery 202 (also referred to as “finite energy storage medium”, “power source” or “voltage source”). The battery 202 provides a base level voltage (e.g., a Vcell_tO=3 V in the depicted embodiment) Section 312 of the plot shows the voltage provided by the battery between times T1 and T2 without the boosting provided by the exemplary switching voltage regulator 204. The boosting provided by the switching voltage regulator 204 utilizes the power shown in section 312, which is not useable without boosting in the present application to power the memory device 206, to enhance the voltage provided by the battery 202 to the memory device 206. In an embodiment, the switching voltage regulator 204 provides a boosted voltage greater than the retention voltage 308 as long as it has a minimum voltage (i.e., Vmin) or input voltage of 2 V from the battery. Embodiments may boost voltage values to various values or ranges depending on the application and finite energy storage medium being utilized. As depicted, the switching voltage regulator 204 provides the memory device 206 with boosted voltage above the retention voltage until time T2, thus extending the time that the memory device 206 contents are preserved from time T1 to time T2. Accordingly, the depicted arrangement provides enhanced battery backup power for the memory device 206. In embodiments, the arrangement is used to store important data, such as encryption information for cryptographic modules. In embodiments, another suitable mechanism and circuit may be used to provide the voltage boosting of the switching voltage regulator 204 where such a mechanism where the input voltage is time varying and a saturable reactor is used to adjust an amplification factor.

Embodiments include a system with a switching voltage regulator configured to extend a useable life of a finite power supply, such as a battery, coupled to a memory device. The switching voltage regulator is configured to provide a boost of voltage when the voltage supplied by the battery decreases after a period of time and approaches a retention voltage for the memory device. In an embodiment, the switching voltage regulator “scavenges” the battery to provide the voltage boost from residual battery capacity and other energy in the circuit that would otherwise be not sufficient voltage levels to power a memory device. Embodiments are configured to improve utilization of energy from a finite energy storage medium, such as a battery or cell. In one embodiment, the system and switching voltage regulator is optimized to maximize the utilization of energy from the finite energy storage medium. In embodiments, the switching voltage regulator is in a low power standby mode when the battery is supplying voltage greater than the retention voltage and switches to an active mode when the voltage supplied by the battery approaches the retention voltage. By extending the useable life of the battery (i.e. the time period where it provide voltage greater than retention voltage), embodiments prevent loss of important data and improve the operation of modules that store the important data.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A computer program product for providing voltage to a memory device, the computer program product comprising:
a tangible storage medium readable by a processing circuit and storing instructions for execution by the processing circuit for performing a method comprising:
storing data on the memory device;
providing a voltage from a finite energy storage medium to the memory device when power is not provided by an associated computing system;
measuring the voltage provided; and
boosting the voltage provided by the finite energy storage medium via a switching voltage regulator responsive to the voltage being below a threshold, wherein the switching voltage regulator is coupled to the finite energy storage medium.

2. The computer program product of claim 1, wherein the memory device comprises a static random access memory device.

3. The computer program product of claim 1, wherein the threshold comprises a value that is within a selected safety factor for a retention voltage for the memory device.

4. The computer program product of claim 1, wherein the method further comprises operating the the switching voltage regulator in a low power standby mode when the voltage provided is greater than the threshold.

5. The computer program product of claim 1, wherein the method further comprises notifying a user of a potential data loss responsive to the voltage falling below the threshold.

6. The computer program product of claim 1, wherein the finite energy storage medium comprises a lithium ion battery.

7. The computer program product of claim 1, wherein storing data on the memory device further comprises storing cryptography data on a static random access memory device, wherein the finite energy storage medium and switching voltage regulator are configured to maintain the voltage provided above a retention voltage to prevent loss of the cryptography data.

8. A method for providing voltage to a memory device, the method comprising:
storing data on the memory device;
providing a voltage from a finite energy storage medium to the memory device when power is not provided by an associated computing system;
measuring the voltage provided; and
boosting the voltage provided by the finite energy storage medium via a switching voltage regulator responsive to the voltage being below a threshold, wherein the switching voltage regulator is coupled to the finite energy storage medium.

9. The method of claim 8, wherein storing data on the memory device comprises storing the data on a static random access memory device.

10. The method of claim 8, wherein the threshold comprises a value that is within a selected safety factor for a retention voltage for the memory device.

11. The method of claim 8, further comprising operating the the switching voltage regulator in a low power standby mode when the voltage provided is greater than the threshold.

12. The method of claim 8, further comprising notifying a user of a potential data loss responsive to the voltage falling below the threshold.

13. The method of claim 8, wherein storing data on the memory device further comprises storing cryptography data on a static random access memory device, wherein the finite energy storage medium and switching voltage regulator are configured to maintain the voltage

14. The method of claim 8, wherein providing the voltage from the finite energy storage medium comprises providing the voltage from a lithium ion battery.

15. A system for providing voltage to a memory device, the system comprising:
a finite energy storage medium and a switching voltage regulator, the system configured to perform a method comprising:
storing data on the memory device;
providing a voltage from a finite energy storage medium to the memory device when power is not provided by an associated computing system;
measuring the voltage provided; and
boosting the voltage provided by the finite energy storage medium via a switching voltage regulator responsive to the voltage being below a threshold, wherein the switching voltage regulator is coupled to the finite energy storage medium.

16. The system of claim 15, wherein the memory device comprises a static random access memory device.

17. The system of claim 15, wherein the threshold comprises a value that is within a selected safety factor for a retention voltage for the memory device.

18. The system of claim 15, wherein the method further comprises operating the the switching voltage regulator in a low power standby mode when the voltage provided is greater than the threshold.

19. The system of claim 15, wherein the method further comprises notifying a user of a potential data loss responsive to the voltage falling below the threshold.

20. The system of claim 15, wherein storing data on the memory device further comprises storing cryptography data on a static random access memory device, wherein the finite energy storage medium and switching voltage regulator are configured to maintain the voltage
